(19) United States
(12) Patent Application Publication
(10) Pub. No.: US 2012/0051319 A1
(43) Pub. Date: Mar. 1, 2012

(54) METHOD AND APPARATUS FOR TRANSMITTING CONTROL INFORMATION

(76) Inventors: Yeong Hyeon Kwon, Gyeonggi-do (KR); Min Seok Noh, Gyeonggi-do (KR); Jae Hoon Chung, Gyeonggi-do (KR); Seung Hee Han, Gyeonggi-do (KR); So Yeon Kim, Gyeonggi-do (KR)

(21) Appl. No.: 13/319,330

(22) PCT Filed: May 19, 2010
(86) PCT No.: PCT/KR2010/003161

§ 371 Date: Nov. 7, 2011

Related U.S. Application Data
(60) Provisional application No. 61/179,693, filed on May 19, 2009.

(30) Foreign Application Priority Data
May 19, 2010 (KR) 10-2010-0046899

(51) Int. Cl. H04W 72/04

(52) U.S. Cl. 370/329

(57) ABSTRACT

The present invention relates to a method for receiving control information, comprising: receiving a resource indicator concerning DeModulation Reference Signal (DM-RS) through a DM-RS field of a Physical Downlink Control Channel (PDCCH); and mapping the resource indicator regarding the DM-RS into the control information according to a predetermined condition, wherein the predetermined condition represents whether information that indicates mapping of the DM-RS and the control information is included in the PDCCH.

### FIELD OF THE INVENTION

The present invention relates to a method and apparatus for transmitting control information in a wireless communication system. And, more particularly, the present invention relates to a method and apparatus for transmitting control information by using a DeModulation Reference Signal (DM-RS) resource.

### BACKGROUND ART

Wireless communication systems are evolving extensively in order to provide diverse types of communication services, such as audio and video data, and so on. Generally, a mobile communication system corresponds to a multiple access system that shares available system resource (e.g., bandwidth, transmission power, and so on) so as to be capable of supporting communication between multiple users. Examples of the multiple access system include a CDMA (code division multiple access) system, a FDMA (frequency division multiple access) system, a TDMA (time division multiple access) system, an OFDMA (orthogonal frequency division multiple access) system, an SC-FDMA (single carrier frequency division multiple access) system, an MC-FDMA (multi carrier frequency division multiple access) system, and so on. In a wireless communication system, a user equipment may receive information from a base station via downlink (DL), and the user equipment may transmit information to the base station via uplink (UL). The information being transmitted or received by the user equipment may correspond to data and diverse control information. And, diverse physical channels may exist depending upon the type and purpose of the information being transmitted or received by the user equipment.

### DETAILED DESCRIPTION OF THE INVENTION

### Technical Objects

An object of the present invention is to provide an effective method for transmitting control information in a wireless communication system.

Another object of the present invention is to provide a method for performing efficient resource management, by transmitting diverse control information through a DM-RS resource used in a wireless communication system.

The technical objects of the present invention will not be limited only to the objects described above. Accordingly, additional technical objects of the present application will be set forth in part in the description which follows and in part will become apparent to those having ordinary skill in the art upon examination of the following or may be learned from practice of the present application.

### Technical Solutions

In order to achieve the object of the present invention, according to an embodiment of the present invention, a method of a user equipment for receiving control information in a wireless communication system includes the steps of receiving a resource indicator related to a DeModulation Reference Signal (DM-RS) through a DM-RS field of a Physical Downlink Control Channel, and mapping the resource indicator related to the DM-RS to the control information in accordance with a predetermined condition, wherein the predetermined condition may indicate whether or not information indicating the mapping of the DMRS and the control information is included in the PDCCH.

The method for receiving control information according to the embodiment of the present invention may further include receiving DM-RS configuration information including the mapping rule from the base station, the mapping rule according to which the resource indicator related to the DM-RS is mapped to the control information.

Herein, the predetermined condition may include a case when a specific field value within the DM-RS field is equal to a predetermined value indicating the control information.

The DM-RS field may include multiple sub-fields, and, among the multiple sub-fields, a first sub-field may indicate a type of the control information, and a second sub-field may indicate a value of the control information.

The control information may include DM-RS index information related to operation control of a multi-input multi-output system. Also, the control information may include downlink carrier indicator information for feeding back channel estimation information. Also, the control information may include uplink carrier indicator information for performing resource allocation, when the user equipment performs uplink transmission. Also, the control information may include information related to a feedback transmission mode, the information indicating a feedback information set, which includes at least one or more uplink control information that is to be fed back by the user equipment. Also, the control information may include information related to a change in Sounding Reference Signal (SRS) configuration, which is to be transmitted with respect to a relay station. Also, the control information may include parameter information related to a Coordinated Multi-Point (CoMP) system, which is to be used in the CoMP system. Also, the control information may include piggybacking control information indicating a transmission mode capable of maintaining single carrier priority levels or a multiple carrier transmission mode capable of transmitting a signal by using both control channel and shared channel simultaneously. Also, the control information may include indicator information distinguishing multiple MCS/TBS operations that can be used in uplink transmission. Also, the control information may include indicator information indicating power control parameters on multiple transmission antennae.

In order to achieve the object of the present invention, according to another embodiment of the present invention, a method for transmitting a reference signal from a user equipment in a wireless communication system includes the steps of receiving information for verifying multiple DeModulation Reference Signals (DM-RSs) from a base station, and transmitting a specific DM-RS, among the multiple DM-RSs, to the base station through a Physical Uplink Shared Channel (PUSCH), wherein the specific DM-RS may be selected from a first DM-RS set when transmitting data, and wherein the specific DM-RS may be selected from a second DM-RS set when transmitting specific control information, and wherein a value of the specific control information may be mapped to a DM-RS included in the second DM-RS set.

The method for receiving control information according the other embodiment of the present invention may further include receiving DM-RS configuration information including a mapping rule for mapping the specific control information to a DM-RS included in the second DM-RS set.

The control information may include information on a number of successfully decoded Physical Downlink Control Channels (PDCCHs), among multiple PDCCHs received from the base station. Also, the control information may include information on a number of physical antennae of the base station and information on power amplifier configuration, the information satisfying a predetermined condition by measuring a downlink signal received from the base station and capable of being independently used. Also, the control information may include indicator information related to a user equipment capability, which is required when the user equipment accesses a cell region. Herein, the indicator information related to the user equipment capability may include a number of available physical antennae of the base station, a configuration of a power amplifier than can be used independently, and information on a multiple input multiple output system or information of multiple carrier performance. Also, the control information may include indicator information indicating a specific PUSCH having piggybacked data, among multiple PUSCHs. Also, the control information may include any one of interference information within a cell having the user equipment located therein, reception verification signal respective to a signal received from the base station, and carrier aggregation triggering information.

In order to achieve the object of the present invention, according to yet another embodiment of the present invention, in a wireless communication system, a user equipment includes a reception module configured to receive a radio signal, a transmission module configured to transmit a radio signal, and a processor configured to map a resource indicator related to a DeModulation Reference Signal (DM-RS) to control information in accordance with a predetermined condition, the DM-RS resource indicator being received from a base station through the reception module, so as to perform control operations. Herein, the DM-RS resource indicator may be received through a DM-RS of a Physical Downlink Control Channel, and the predetermined condition may indicate whether or not information indicating the mapping between the DM-RS and the control information is included in the PDCCH, and the processor may perform an operation of transmitting a DM-RS to the base station through the transmission module, the DM-RS being configured based upon the DM-RS configuration information indicated by the DM-RS resource indicator.

The technical objects that are to be achieved in the present invention will not be limited only to the technical objects described above. Accordingly, additional technical objects of the present application will be set forth in part in the description which follows and in part will become apparent to those having ordinary skill in the art upon examination of the following or may be learned from practice of the present application. More specifically, technical objects that are not mentioned herein may also be understood by anyone having ordinary skill in the art.

### Effects of the Invention

According to the exemplary embodiments of the present invention, diverse control information may be efficiently transmitted in a wireless communication system.

Also, according to the exemplary embodiments of the present invention, by re-using the DM-RS resource for the transmission of control information, diverse control information may be efficiently transmitted.

The effects that may be gained from the embodiment of the present invention will not be limited only to the effects described above. Accordingly, additional effects of the present application will be set forth in part in the description which follows and in part will become apparent to those having ordinary skill in the art upon examination of the following or may be learned from practice of the present application. More specifically, unintended effects obtained upon the practice of the present invention may also be derived by anyone having ordinary skill in the art.

### BRIEF DESCRIPTION OF THE DRAWINGS

The accompanying drawings, which are included to provide a further understanding of the invention and are incorporated in and constitute a part of this application, illustrate embodiments of the invention and along with the description serve to explain the spirit and scope (or principle) of the invention.

FIG. 1 illustrates an exemplary network structure of an E-UMTS.

FIG. 2 illustrates an exemplary structure of a radio frame used in an LTE.

FIG. 3 illustrates a physical channel of an LTE system and an exemplary signal transmission using the physical channel.

FIG. 4 illustrates an exemplary structure of a downlink subframe.

FIG. 5 illustrates an exemplary structure of an uplink subframe.

FIG. 6 illustrates an exemplary process performed by the base station for transmitting a reference signal through a downlink channel according to an exemplary embodiment of the present invention.

FIG. 7 illustrates another exemplary process performed by the user equipment the base station for transmitting a reference signal through a downlink channel according to an exemplary embodiment of the present invention.

FIG. 8 illustrates a block view showing the structures of an exemplary base station and an exemplary user terminal that can perform the embodiment of the present invention.

### BEST MODE FOR CARRYING OUT THE PRESENT INVENTION

Hereinafter, the structure, operation, and other characteristics according to the preferred embodiments of the present invention will now be described in detail with reference to the accompanying drawings and the details given in the accompanying drawings. The exemplary embodiments of the present invention may be used in diverse wireless (or radio) access technologies, such as CDMA, FDMA, TDMA, OFDMA, SC-FDMA, MC-FDMA. More specifically, CDMA may be implemented in wireless (or radio) technologies, such as UTRA (Universal Terrestrial Radio Access) or CDMA2000. TDMA may be implemented in wireless (or radio) technologies, such as GSM (Global System for Mobile communications)/GPRS (General Packet Radio Service)/EDGE (Enhanced Data Rates for GSM Evolution). OFDMA may be implemented in wireless (or radio) technologies, such as IEEE 802.11 (Wi-Fi), IEEE 802.16 (WiMAX), IEEE 802.20, E-UTRA (Evolved UTRA), and so on. UTRA is part of UMTS (Universal Mobile Telecommunications System). 3GPP (3rd Generation Partnership Project) LTE (long term evolution) is part of E-UMTS (Evolved UMTS) using E-UTRA. LTE-A (Advanced) corresponds to an evolved version of 3GPP LTE.

Hereinafter, the preferred embodiments of the present invention correspond to examples wherein the technical characteristics of the present invention are applied in a 3GPP system. However, this is merely exemplary. And, therefore, the present invention will not be limited only to the exemplary embodiments presented herein.

Although the description of the present invention is based upon the LTE-A, the proposed concept or proposed methods and the exemplary embodiments of the same may also be applied to another type of system using multiple carriers (e.g., IEEE 802.16m) without any limitations.

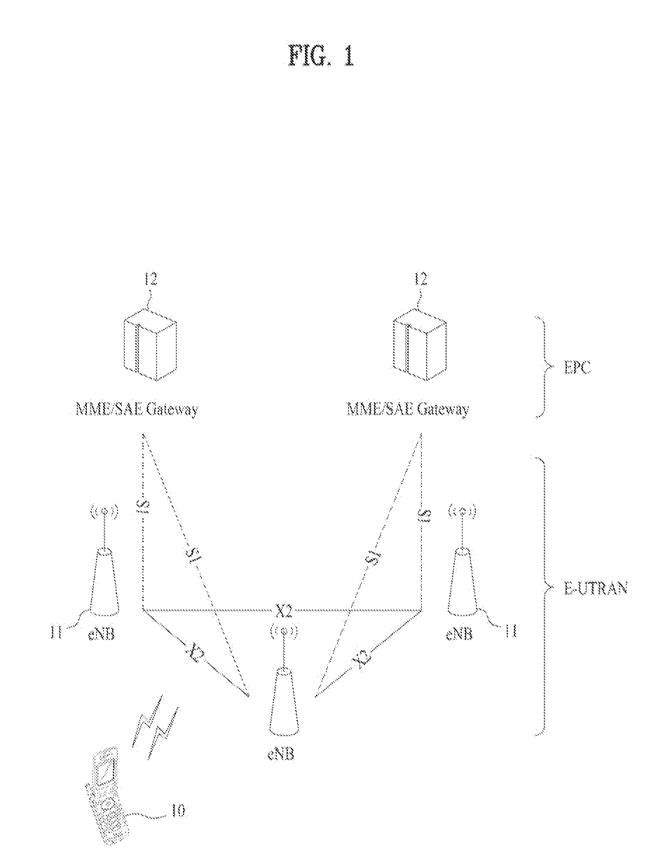

FIG. 1 illustrates an exemplary network structure of an E-UMTS. The E-UMTS may also be referred to as an LTE system. Herein, being positioned throughout a wide area, a communication network may provide diverse communication services, such as voice and packet data.

Referring to FIG. 1, an E-UMTS network includes an E-UTRAN (Evolved Universal Terrestrial Radio Access Network), EPC (Evolved Packet Core), and a User Equipment (UE). The E-UTRAN includes at least one or more base stations (eNodeBs; eNBs) (11), and at least one or more user equipments (10) may be located in a single cell. A Mobility Management Entity/System Architecture Evolution (MME/SAE) gateway (12) may be located at an end portion of the network so as to be connected to an external network. A downlink refers to a communication performed from the base station (11) to the user equipment (10), and an uplink refers to a communication performs from the user equipment (10) to the base station (11).

The user equipment (10) corresponds to a portable communication device that can be used by a user, and the base station (11) corresponds to a fixed station, which generally communicates with the user equipment (10). The base station (11) provides end points of a user plane and a control plane to the user equipment (10). One base station (11) may be located in each cell. An interface configured to transmit user traffic or control traffic may be used between the base stations (11). The MME/SAE gateway (12) provides end points of a session and mobility management function to the user equipment (10). The base station (11) and the MME/SAE gateway (12) may be connected to one another through an S1 interface.

The MME provides diverse functions including distribution of paging messages to base stations (11), security control, idle state mobility control, SAE bearer control, encryption of non-access stratum (NAS) layer signaling, and integrity protection. An SAE gateway host provides diverse functions including ending (or terminating) a plane packet, and switching a user plane for supporting the mobility of a user equipment (10). In the description of the present invention, the MME/SAE gateway (12) will be referred to as a gateway for simplicity, the gateway including both MME and SAE gateways.

Multiple nodes may be connected between the base stations (11) and the gateways (12) through an S1 interface. The base stations (11) may be interconnected through an X2 interface, and neighboring base stations may have a mesh network structure including the X2 interface.

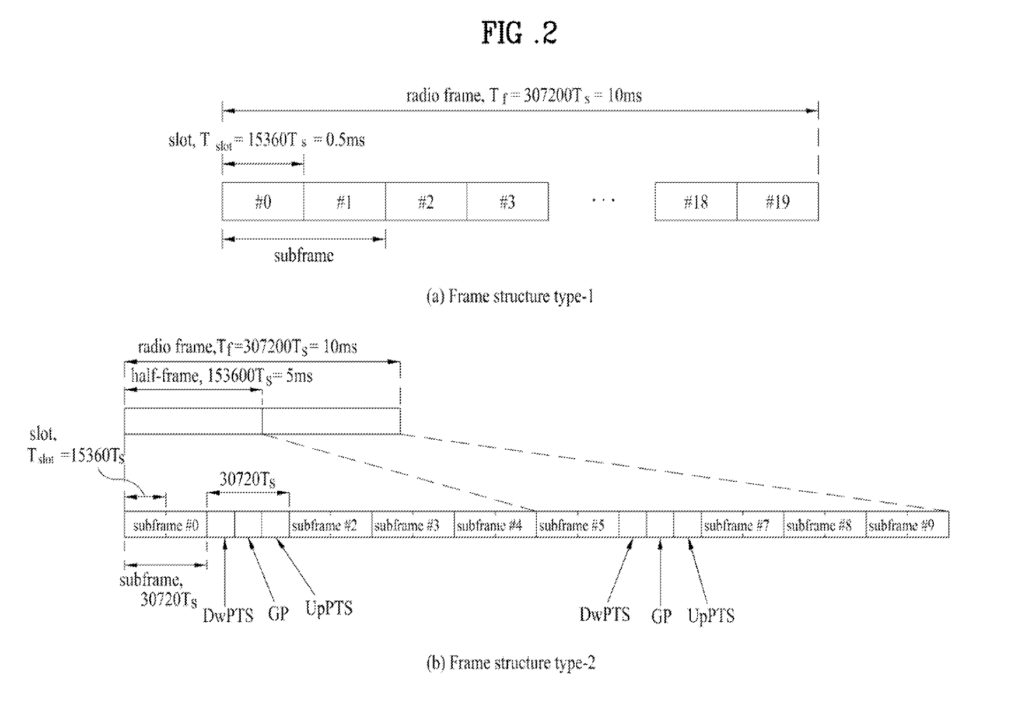

FIG. 2 illustrates an exemplary structure of a radio frame used in an LTE.

Referring to FIG. 2, a radio frame has the length of 10 ms (327200*Tₛ) and includes ten (10) subframes each having the same size. Each subframe has the length of 1 ms and includes of two (2) 0.5 ms slots. Each slot has the length of 0.5 ms (15360×Tₛ). Herein, Tₛ represents a sampling time and is indicated as Tₛ=1/(15 kHz×2048)=3.2552*0⁻⁸ (approximately 33 ns). A slot includes a plurality of OFDM (Orthogonal frequency Division Multiplexing) (or SC-FDMA) symbols in the time domain and includes a plurality of Resource Blocks (RBs) in the frequency domain. In the LTE system, one resource block includes 12 subcarriers*7(6) OFDM (or SC-FDMA) symbols. Frame structure type-1 and -2 are respectively used in FDD and TDD. The frame structure type-2 includes two (2) Half Frames, and each Half Frame includes five (5) subframes, a Downlink Piloting Time Slot (DwPTS), a Guard Period (GP), and an Uplink Piloting Time Slot (UpPTS). The above-described radio frame structure is merely exemplary. And, therefore, the number/length of the subframes, slots, or OFDM (or SC-FDMA) symbols may be diversely varied.

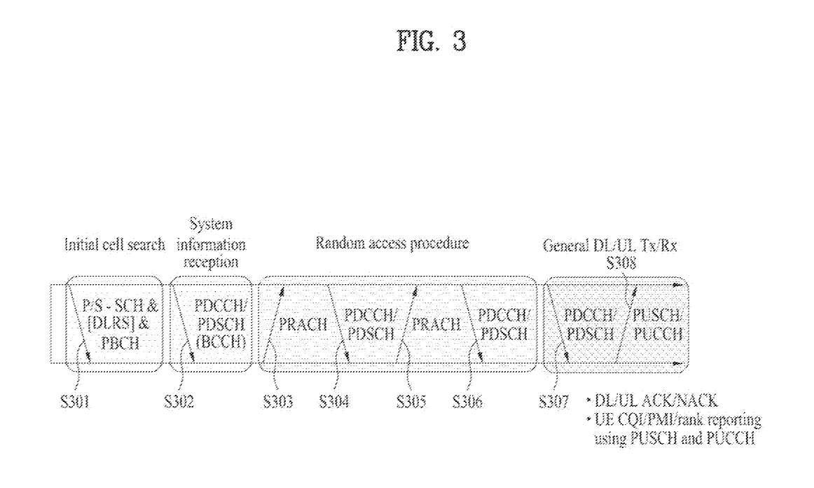

FIG. 3 illustrates a physical channel of an LTE system and an exemplary signal transmission using the physical channel.

The user equipment performs initial cell search such as synchronization with the base station, when it newly enters a cell or when the power is turned on (S301). In order to do so, the user equipment synchronizes with the base station by receiving a Primary Synchronization Channel (P-SCH) and a Secondary Synchronization Channel (S-SCH) from the base station, and then acquires information such as Cell Identity (ID), and so on. Thereafter, the user equipment may acquire broadcast information within the cell by receiving a Physical Broadcast Channel from the base station. Once the user equipment has completed the initial cell search, the corresponding user equipment may acquire more detailed system information by receiving a Physical Downlink Control Channel (PDCCH) and a Physical Downlink Control Channel (PDSCH) based upon the respective information carried in the PDCCH (S302).

Meanwhile, if the user equipment initially accesses the base station, or if there are no radio resources for signal transmission, the user equipment may perform a Random Access Procedure (RACH) with respect to the base station (S303 to S306). In order to do so, the user equipment may transmit a specific sequence to a preamble through a Physical Random Access Channel (PRACH) (S303 and S305), and may receive a response message respective to the preamble through the PDCCH and the PDSCH corresponding to the PDCCH (S304 and S306). In case of a contention based RACH, a Contention Resolution Procedure may be additionally performed.

After performing the above-described process steps, the user equipment may perform PDCCH/PDSCH reception (S307) and Physical Uplink Shared Channel (PUSCH)/Physical Uplink Control Channel (PUCCH) transmission (S308), as general uplink/downlink signal transmission procedures.

The control information, which is transmitted by the user equipment to the base station or received by the user equipment from the base station via uplink, includes downlink/uplink ACK/NACK signals, an SR (Scheduling Request), a CQI (Channel Quality Indicator), a PMI (Precoding Matrix Index), an RI (Rank Indicator), and so on. In case of the 3GPP LTE system, the user equipment may transmit control information, such as the above-described CQI/PMI/RI through the PUSCH and/or the PUCCH.

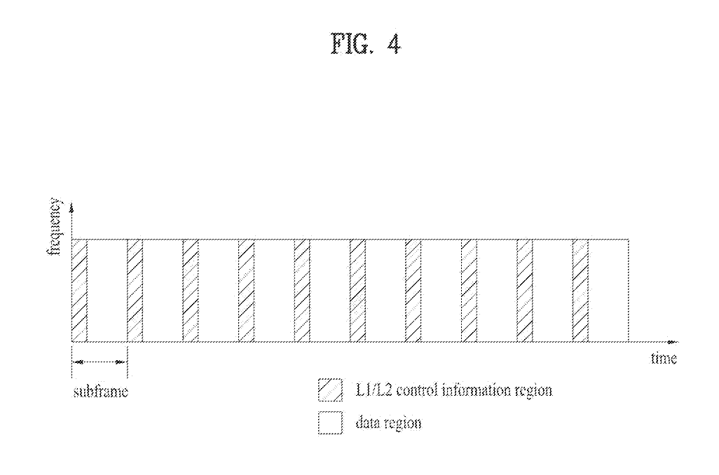

FIG. 4 illustrates an exemplary structure of a downlink subframe.

Referring to FIG. 4, a subframe includes an L1/L2 control information region (layer1/layer 2 control information region) configured to transmit scheduling information and other control information, and a data region (date region) configured to transmit downlink data. and a time section for transmitting other control information (control region) and a time section for transmitting downlink data (data region). The size of the control region may be independently set-up (or determined) for each subframe. Diverse control channels including a PDCCH (Physical Downlink Control Channel) are mapped to the control region. The PDCCH corresponds to a physical downlink control channel, which is assigned to the first n number of OFDM symbols of a subframe. The PDCCH includes one or more Control Channel Elements (CCEs). Each CCE includes nine (9) adjacent Resource Element Groups (REGs), and each REG consists of 4 REs adjacent to one another while excluding a reference signal. An RE corresponds to a minimum resource unit defined as one (1) subcarrier*one (1) symbol.

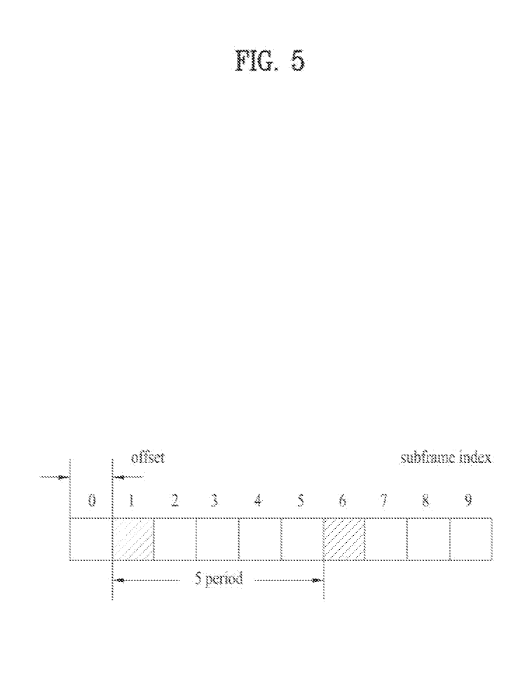

FIG. 5 illustrates an exemplary structure of an uplink subframe.

Referring to FIG. 5, a subframe (500) having the length of 1 ms, which corresponds to a basic unit for uplink transmission, configured of two (2) 0.5 ms slots (501). When the length of a normal cyclic prefix is assumed, each slot is configured of seven (7) symbols (502), and one symbol corresponds to one SC-FDMA symbol. A Resource Block (RB) (503) refers to a resource allocation unit corresponding to 12 subcarriers in the frequency domain and one slot in the time domain. An uplink subframe is divided into data region (504) and a control region (505). The data region includes a physical uplink shared channel (PUSCH), and the data region is used for transmitting data signals, such as voice, images, and so on. The control region includes a physical uplink control channel (PUCCH), and the control region is used for transmitting control information. The PUCCH includes an RB pair located at each end portion of the data region along a frequency axis, and the PUCCH hops at a slot boundary.

Give an example of DMRS field using PDCCH DCI format, give an example of a method of having the user equipment select a DMRS (Let's refer to detailed descriptions of related art inventions in the morning to elaborate this part)

Following the description of the DMRS, in an uplink subframe the DM-RS is mapped to 12 REs for each resource block, thereby being transmitted. The number of cyclic shifts that can be used in a DM-RS sequence may be differently defined depending upon the CP length. Accordingly, the number of available cyclic shifts for normal CPs and extended Cps may be diversely implemented.

However, regardless of the number of cyclic shifts, not all of the cyclic shifts are used. In order to transmit and demodulate data, only one cyclic shift is used for demodulating one rank or one layer, each being used to transmit data. Most particularly, when only one power amplifier is used for an uplink transmission in an LTE system, this indicates that only a Rank 1 transmission is available. More specifically, based upon one RB in a resource structure, when using a resource corresponding to 12 sequences corresponding to the DM-RS, a maximum of eight (8) degrees of freedom may actually be used for the DM-RS transmission. The user equipment may configure a DM-RS sequence, which is to be used over an uplink channel depending upon the information indicated by the base station, or the user equipment may configure a DM-RS sequence depending upon a DM-RS sequence cyclic shift information shared by the base station and the user equipment, thereby transmitting the configured DM-RS sequence via uplink.

Accordingly, the base station may indicate through the PDCCH field information notifying that the user equipment may use 8 degrees of freedom when configuring the DM-RS and also that the user may use the degrees of freedom for additionally transmitting other information. More specifically, the degree of freedom may be used for transmitting additional information, which is configured for uplink data transmission, along with other downlink/uplink control information.

Therefore, the present invention seeks to propose a method for transmitting diverse control information using a degree of freedom in an LTE-A system. Hereinafter, in the description of the present invention, the method for transmitting control information will be described in detail, wherein the DM-RS is given as an example of the reference signal.

### 1. First Embodiment

### Control Information Transmission from the Base Station to the User Equipment

Generally, the base station transmits cyclic shift information respective to an uplink DM-RS to the user equipment over a PDCCH. After receiving the transmitted cyclic shift information, the user equipment configures a predetermined uplink DM-RS based upon the indication information transmitted from the base station, thereby transmitting the configured uplink DM-RS along with the data and/or control information through the PUSCH.

By using the method for indicating the uplink DM-RS through PDCCH from the base station, the present invention seeks to propose a method for re-translating indication information respective to the uplink DM-RS as control information based upon pre-defined mapping information, which may be defined in accordance with a higher layer signaling or in accordance with a predetermined rule.

Generally, the DM-RS field may use a Downlink Control Information (DCI) format, which was initially used in the conventional LTE system. DCI format 0 may be used for scheduling PUSCH.

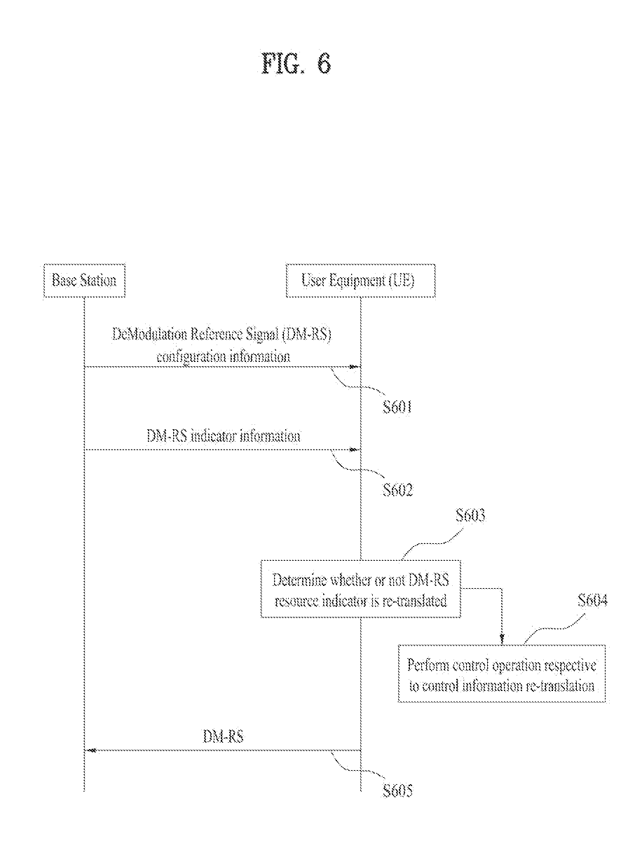

FIG. 6 illustrates an exemplary process performed by the base station for transmitting a reference signal through a downlink channel according to an exemplary embodiment of the present invention.

Referring to FIG. 6, the base station transmits DM-RS configuration information to the user equipment (S601). Herein, ‘DM-RS configuration information’ includes information related to a mapping rule enabling a ‘DM-RS resource indicator’, which is transmitted later on by the base station through the PDCCH, to be re-translated as control information.

Herein, the ‘DM-RS resource indicator’ may be defined as information on a number of cyclic shifts of a DM-RS sequence, which is transmitted later on by the user equipment to the base station, or the ‘DM-RS resource indicator’ may be defined as information that is re-translated as control information in accordance with the mapping rule. For example, when 3 bits are assigned to the DM-RS resource indicator so as to be determined as ‘010’, the DM-RS may be configured by translating this information as the cyclic shift of the DM-RS sequence being applied 3 times in a legacy system through ‘101’. According to an exemplary embodiment of the present invention, the DM-RS resource indicator, which is determined as ‘010’, may be re-translated as an indicator indicating any one of the control information, which will be described later on. Herein, the mapping rule refers to a rule for translating information indicated by such DM-RS resource indicator.

The mapping rule of mapping the DM-RS resource indicator to the control information may be arbitrarily configured by the base station and transmitted to the user equipment, or the mapping rule may be predetermined in the base station and/or the user equipment.

Thereafter, the base station transmits DM-RS indicator information including the DM-RS resource indicator to the user equipment (S602). Herein, the ‘DM-RS indicator information’ corresponds to information including a first DM-RS resource indicator indicating the cyclic shift of the DM-RS, which is to be transmitted by the user equipment to the base station, and/or a second DM-RS resource indicator that may be re-translated as control information. More specifically, the DM-RS indicator information may include multiple DM-RS resource indicators depending upon the respective configuration format. Herein, the number of bits being assigned to the indicator information may vary depending upon the number of indicators included in the DM-RS indicator information.

In this step, the base station may select any one the diverse control information, which may be transmitted through the DM-RS resource indicator, and may map the selected control information to the DM-RS resource indicator, thereby performing transmission. According to an exemplary embodiment of the present invention, the control information that may be re-translated through the DM-RS resource indicator will be described later on in more detail.

In order to configure the DM-RS indicator information, the base station may configure indicator information, wherein the indicator information includes the type of control information that is to be transmitted through the DM-RS resource and a location at which the control information is include, based upon the degree of freedom respective to the DM-RS in the overall sequence configured for DM-RS transmission.

The base station divides a field that is configured to transmit DM-RS indicator information (hereinafter referred to as DM-RS field') into a multiple fields. Thereafter, the base station may map the DM-RS resource indicator indicating the cyclic shift of the DM-RS and/or the DM-RS resource indicator that may be re-translated as control information to each of the divided fields. At this point, a position or value of a new DM-RS that is to be configured by the user equipment through the DM-RS resource indicator indicating the DM-RS cyclic shift may be indicated.

The DM-RS field according to exemplary embodiment of the present invention may additionally include a field including a DM-RS resource indicator configured for DM-RS configuration, which is used in the conventional legacy system, and may also additionally include a field including a DM-RS resource indicator that may be used in a downlink control command or an uplink control command. For example, a DM-RS field including multiple sub-fields may be configured to have a first sub-field, among the multiple sub-fields, indicate a type of the control information, and to have a second sub-field indicate a value of the control information.

Also, the division of the DM-RS field may be selectively (or optionally) performed, in case a mutual supplementation process is added during a procedure for calculating a DM-RS index. For example, when a mapping table between a bit string and a DM-RS index resources exists, or when a higher-layer configuration exists within an index where the DM-RS begins, the number of bits configuring the DM-RS resource indicator may be decreased, and process steps of the division process of the DM-RS field may be reduced.

Furthermore, the used amount of the DM-RS may be varied in accordance with a field configuration method, based upon a number of control information, which may be transmitted through a DM-RS field, among the predefined diverse control information.

After receiving the above-described DM-RS indicator information, the user equipment may determine whether or not to re-translate the DM-RS resource indicator included in the indicator information as control information based upon a mapping rule, which is either predetermined or received from the base station (S603).

At this point, when the DM-RS resource indicator is re-translated as control information, control information is detected from the DM-RS resource indicator, and control operation respective to the detected control information may be performed. Depending upon the control information, the user equipment may perform the indicated control operations or may perform operations required for user equipment management (S604).

Alternatively, as performed in the conventional legacy system, a newly configured DM-RS signal, which is newly configured in accordance with the DM-RS resource indicator, may be transmitted to the base station through a PUSCH or a PUCCH (S605).

Hereinafter, the diverse control information that may be transmitted through DM-RS indicator information, which is transmitted to the user equipment from the base station through the PDCCH, will be described below.

1) MIMO Operation Control Information

The DM-RS index may be used as a PMI indicator or as rank information depending upon the position of the index allocated to the DM-RS.

2) Downlink Carrier Indicator Information for Feeding-Back Information Respective to Channel Estimation

Since multiple downlink carriers may be included in a carrier that is to be monitored by the user equipment, the base station may use a DM-RS index for transmitting control information indicating the carrier, which is to be used in order to enable the user equipment to report channel estimation information. Alternatively, the DM-RS index may also be used in order to indicate a downlink carrier ID within a user equipment space or cell-specific carrier space included at least one or more user equipments. The DM-RS index and the downlink carrier ID may be mapped to be in a one-to-one correspondence or in a one-to-multiple correspondence. A measurement carrier indicator may be defined as a bit (carrier bit or bitmap) that is newly assigned to the PDCCH. A field including the measurement carrier indicator is referred to as a Carrier Indication Field (CIF). And, in case of transmitting the measurement carrier indicator configurations may be made so that a separate CIF is included in the PDCCH.

Alternatively, unlike the method of configuring a CIF in the PDCCH so as to assign a new bit, a mapping process between the DM-RS index and the downlink carrier index may be implicitly performed in an overhead surface.

3) Uplink Carrier Indication for Resource Allocation

An uplink target carrier may be defined based upon a DM-RS bit selection. According to the exemplary embodiment of the present invention, a carrier indicator may be transmitted in order to perform an uplink resource allocation in an asymmetric carrier group. Similarly, the carrier indicator may be transmitted through the Carrier Indication Field (CIF). Based upon the number of uplink synchronization transmission carriers, 1 bit or 2 bits may be assigned as the uplink carrier indicator. Information on the resource allocation may be implicitly applied when selecting a DM-RS or may be explicitly applied as divided bits of the DM-RS indicator bits. Uplink carrier indicator information indicates that a sub-set of a DM-RS candidate belongs to a specific uplink carrier, and the uplink carrier indicator information may be decided by the bases station or may be predetermined when configuring the system.

Meanwhile, additional bits being included in a CIF and transmitted may be used as carrier index, when uplink carrier indicator information respective to resource allocation is implicitly transmitted.

4) Feedback Mode Indicator Information within an Uplink Control Feedback

Generally, in the operations of a legacy system, the user equipment may perform feedback transmission on feedback information, which includes CQI, RI, and ACK/NACK information based upon channel estimation, to the base station through a single PUSCH. At this point, when the number of information that is to be transmitted as feedback (or feedback transmitted) becomes larger, it will be inefficient to transmit all feedback information though a single PUSCH.

Therefore, the base station according to the embodiment of the present invention may decide at least one or more feedback information that are to be simultaneously transmitted via PUSCH transmission, and feedback mode indicator information related to a feedback information set including the at least one or more decided feedback information through a DM-RS field. More specifically, when the control information that is to be transmitted by the user equipment is fed-back over a shared channel, the feedback information may be controlled in accordance with a base station indication transmitted through the DM-RS over the PDCCH.

The user equipment may transmit the feedback information through a PUCCH or through both PUSCH and PUCCH. The selected DM-RS may indicate a transmission mode (actual content) of the UCI from the feedback information.

5) Sounding Reference Signal Operation Indicator Information

In a general LTE-A system, each time a Sounding Reference Signal (SRS) configuration is changed, the user equipment may be informed of the changed SRS configuration information. Conversely, the relay stations (relays) may not be informed of the changed SRS configuration information each time the SRS configuration information is changed. Moreover, according to the operations of such relay stations, an uplink SRS configuration should be informed in advance by the PDCCH information. For example, the SRS operation indicator information may be transmitted through a DM-RS field with respect to a DM-RS index position. The SRS operation indicator information may be included in SRS configuration information, such as a periodic configuration or an antenna configuration corresponding to a next SRS transmission. The SRS operation indicator information may include Precoding Matrix Indication (PMI), a number of antennae used for the synchronized (or simultaneous) transmission, SRS position information, and SRS overhead information.

6) CoMP Related Parameter

A Coordinated Multi-Point (CoMP) system refers to a system for enhancing a processing amount of a user located at a cell boundary by applying an enhanced MIMO transmission in a multi-cell environment. When applying the CoMP system, Inter-Cell Interference within the multi-cell environment may be reduced. When using such CoMP system, the user equipment may be supported with shared data from a Multi-cell base station. Also, each base station may use the Same Radio Frequency Resource so as to simultaneously support at least one or more user equipments (MS1, MS2, . . . MSK), thereby enhancing the system performance. Furthermore, the base station may perform a Space Division Multiple Access (SDMA) method based upon the channel state information between the base station and the user equipment.

In case of the CoMP operation, the base station may control a sub-set of a corresponding CoMP cell set or a specific cell ID. And, in order to perform the control operations, the base station may transmit CoMP related parameters, such as a cell ID, through the DM-RS field.

Since the CoMP related parameter information may be transmitted through the DM-RS field, a CoMP measurement corresponding to a specific cell may be reported by an allocated resource. Also, uplink CoMP operation may be available in accordance with the DM-RS operation. In case of the uplink CoMP operation, the base station may indicate in advance a reception mode or information on a common virtual resource, which is used for CoMP reference signal transmission, to the user equipment. More specifically, the base station may simultaneously transmit a route sequence index and cyclic shift information of a CoMP cell set through the DM-RS field.

By performing CoMP related parameter information transmission, the MIMO system may be expanded to a CoMP system.

7) Piggybacking Control Information

An LTE-A system includes a first uplink transmission mode, which corresponds to a legacy transmission mode for maintaining a single carrier priority, and a second uplink transmission mode, which is used in a multiple carrier transmission, wherein a control channel and a shared channel may be simultaneously transmitted.

In order to support the above-described two operation modes, it is necessary to define a method for indicating a transmission mode configuration. For example, a transmission mode may be defined by a higher layer signaling, or indicator information indicating whether or not piggybacking has been performed may be transmitted through the PDCCH.

However, since the transmission mode indicator information is required when simultaneously transmitting control information and data, the transmission mode may be implicitly indicated. Such indicator information may be included in the DM-RS field and transmitted. Since the indicator information may be defined by a DM-RS shift position, a specific DM-RS position refers to control channel piggybacking, and another position indicates that piggybacking is not performed.

8) MCS/TBS Differentiation Indicator Information

When multiple MCS/TBS tables that may be used for uplink transmission exist, MCS/TBS operations may be identified (or differentiated) by measurement. And, the differentiation of the MCS/TBS operations may be indicated in the form of higher layer signaling or direct indicator information. By directly indicating the indicator information by using a predetermined number of bits, or by implicitly indicating indicator information over the DM-RS index, a specific DM-RS index may also be used as information for indicating differentiated MCS/TBS. The differentiated MCS/TBS table may correspond to a multiple set of the MCS/TBS, any one of the sub-sets or to a limited set of the MCS/TBS.

9) Power Control Parameter

According to the current power control mechanism, it is necessary to indicate additional power control parameters for multiple transmission antennae. The added power control parameters may be used by the overall antenna or in a power gain offset. For example, power control may be defined as a case when the power control increases (one cyclic shift index) and as a case when the power control decreases (another index). In another example, a power control target is separately defined with respect to each cyclic shift. Accordingly, each power control target may be respectively defined as one cyclic shift (antenna/power amplifier 1), another cyclic shift (antenna/power amplifier 2), and so on.

### 2. Second Embodiment

### Control Information Transmission from the User Equipment to the Base Station

The user equipment may configure a DM-RS based upon DM-RS indicator information transmitted from the base station and may transmit the configured DM-RS.

As described above, in accordance with a predetermined information mapping procedure, which may be defined based upon higher layer signaling or defined by a predetermined rule, the DM-RS indicated in the PDCCH may be reused as another cyclic shift.

The user equipment may select a DM-RS, based upon the control information that the user equipment wishes to transmit. The DM-RS set that is used for selecting the DM-RS may be defined as a limited cyclic shift, which is defined by a total number of cyclic shifts or implicitly/explicitly defined by higher layer signaling or specific. The cyclic shift set may include a DM-RS that is used by a legacy user equipment or may include an unused cyclic shift that is not included in the mapping table. Therefore, when it is assumed that the total number of DM-RSs that may be arbitrarily selected by the user equipment based upon unused cyclic shifts is equal to Na (Na>1), among the Na number of DM-RSs, the user equipment may select control information that is to be transmitted based upon one or more DM-RSs.

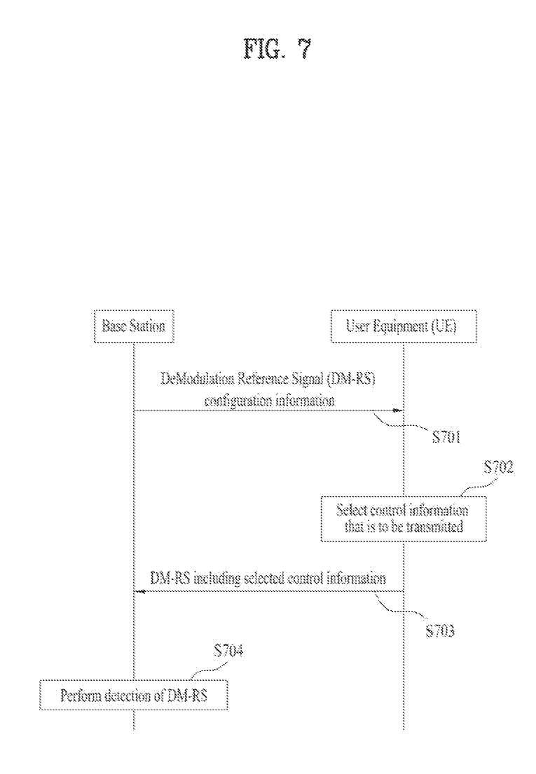

FIG. 7 illustrates another exemplary process performed by the user equipment the base station for transmitting a reference signal through a downlink channel according to an exemplary embodiment of the present invention.

Referring to FIG. 7, the base station may transmit to the user equipment DM-RS configuration information respective to a mapping rule, which may be used for re-translating a DM-RS resource indicator as control information, to the user equipment (S701). Since the description of the same is identical to the description of step S601 shown in FIG. 6, a detailed description of the same will be omitted for simplicity. Instead of being transmitted from the base station, the mapping rule translating the DM-RS resource indicator as control information may be predetermined in the base station and/or the user equipment.

Thereafter, the user equipment may select a DM-RS, which the user equipment wishes to transmit (S702).

The DM-RS set includes a first DM-RS set, which is to be selected when transmitting data, and a second DM-RS set, which may be re-translated as control information. The second DM-RS set may be configured of DM-RSs that may be arbitrarily selected by the user equipment based upon unused cyclic shifts. And, when it is assumed that the number of DM-RSs included in the second DM-RS set is equal to Na (Na>1), among the Na number of DM-RSs, the user equipment may select one or more DM-RSs and may transmit the corresponding control information. Then, the selected control information may have been received from the base station in the previous process step or may be mapped to DM-RSs that are predetermined in accordance with a mapping rule. Thereafter, the user equipment transmits the DM-RSs, which are respectively mapped to the selected control information, to the base station (S703).

Subsequently, the base station performs detection of the transmitted DM-RS (S704). At this point, when the detected DM-RS belongs to an unused DM-RS set, the base station may map the detected DM-RS to the control information, or the base station may re-translate the detected DM-RS as the control information, in accordance with signaling or a pre-decided mapping rule. In case of the LTE, among the 2 DM-RSs that may be configured by using one sequence, since 4 DM-RSs (more specifically, the cyclic shifts respective to the corresponding DM-RS sequence) belong to the unused DM-RS set, the user equipment may use the DM-RS to transmit a 2-bit information to the base station.

Hereinafter, diverse control information that may be transmitted through the DM-RS will now be described in detail.

1) DTX Indicator Information

The user equipment includes indicator information indicating a number of PDCCHs, which are received while receiving multiple PDCCHs from the base station, in a DM-RS field through the PUCCH or PUSCH and may transmit the indicator information included in the DM-RS field to the base station. When the number of cyclic shifts (Na) of the DM-RS that may be selected by the user equipment is greater than the number of integrated downlink carriers, among the Na number of sets, the user equipment selects adequate DM-RS cyclic shifts, thereby being capable of successfully reporting the information on the number of decoded PDCCHs to the base station.

The number of adequate DM-RSs selected by the user equipment may be defined by an offset value correspond to a starting point, among the indexes of the indicated PDCCH, or a cyclic shift value. Herein, the offset value may be defined by a value excluding a number of one PDCCH from the number of received PDCCHs (offset value=the number of PDCCH received−1).

2) Random Access and LTE-A User Equipment Capability Indicator Information

The control information that is reported by the user equipment to the base station may, for example, include information on a number of available physical antennae, information on a configuration of a power amplifier that may be used independently, and information on MIMO performance or multiple carrier performance. The information on such user equipment capability may be required during an initial access procedure, which is performed when the user equipment accesses a cell, such as a random access procedure. In case of the conventional LTE system, an agreement procedure (legacy agreement procedure) for exchanging user equipment capabilities exist before an actual access is realized between the user equipment and the base station. Therefore, information related to the user equipment capability may be transmitted in accordance with the conventional agreement procedure. With respect to the user equipment capability information (e.g., LTE-A specific user equipment capability), which is added in the LTE-A, when a new method related to an agreement between the LTE-A user equipment and the base station does not exist, the agreement procedure related to the LTE-A specific user equipment capability may be performed after the legacy agreement step. In this case, a separate agreement step related to the user equipment capability should be added. And, accordingly, a latency may be added for the agreement related to the user equipment capability. Therefore, instead of adding a new agreement step related to the user equipment capability, it will be more required to maintain the same number of steps required for performing the initial access procedure as that of the convention LTE system.

The distinction between an LTE user equipment and an LTE-A user equipment may be performed by using a first message for random access, and second message and third message, each corresponding to a preamble response message. For example, during a random access procedure, when the LTE user equipment is differentiated from the LTE-A user equipment by using the first message, the LTE-A user equipment uses a preamble (second preamble) that is different from the legacy preamble (first preamble), which is used by the LTE user equipment. Accordingly, when transmitting an LTE-A preamble response message (second message), the base station may use a PDCCH, which is different from the PDCCH designated for an LTE preamble response message. The PDCCH that is used for transmitting the second message may be differentiated by using a Random Access-Radio Network Temporary Identifier (RA-RNTI) respective to the LTE user equipment and the LTE-A user equipment. Accordingly, the LTE-A user equipment may receive a different random access response from the LTE-A base station, and the user equipment may include information related to the corresponding user equipment capability in a third message, as a response to the received random access response, which may then be reported to the base station.

LTE-A user equipment capability, such as carrier aggregation capability, number of physical antennae, number of power amplifiers, and CoMP related capabilities, may be transmitted through a shared channel or a DM-RS index.

When the LTE-A capability is transmitted over a shared channel, a demodulation coding or an uplink grant, which is different from that used in a conventional LTE random access message 3, is required to be allocated. For this, the PDCCH for the random access response should be configured differently from that of the conventional LTE. Or, depending upon the configuration of a higher-level layer, the random access response should be translated differently from that of the conventional LTE. When a PDCCH designated for the LTE-A user equipment exists separately, it is not necessary to define a translation that is implicitly differentiated with respect to a third message transmission. For example, when a transmission format respective to the third message may be defined in advance, and the transmission format (modulation and coding method) may be indicated by the PDCCH.

If a PDCCH separately defined for the LTE-A user equipment does not exist, the LTE-A user equipment may differently translate the RAR, which is the same as that of the convention LTE. Accordingly, contents of the third message, which is transmitted by the LTE-A user equipment, may be different from the contents of the third message, which is transmitted by the legacy LTE user equipment. Information for differently translating the RAR may be defined in the LTE-A system information. If a shared channel is not used for the LTE-A capability transmission, the information on the corresponding LTE-A user equipment capability may be transmitted through a DM-RS cyclic shift selection. More specifically, information on a number of available physical antennae supported by the user equipment, information on a configuration of a power amplifier that may be used independently, and information on MIMO performance or multiple carrier performance may be indicated in accordance with a specific DM-RS, which is selected from a set of available DM-RS cyclic shifts.

The distinction (or differentiation) between the LTE user equipment and the LTE-A user equipment by using a preamble may be defined as a set definition respective to an LTE-A user equipment preamble from a designated preamble sequence or a range of unavailable sequences (wherein the range is limited to parameter configurations of a first preamble group and the second preamble group). If the preamble cannot be differentiated, the LTE-A base station may arbitrarily transmit a different PDCCH, and the LTE-A user equipment may receive the transmitted PDCCH and may perform operations different those of the LTE user equipment. When an implicit translation is applied, the related indicator information may be identified as distinctive indicator information through the system information or may be identified from base station version information, such as the LTE-A base station.

3) Scheduling Request Information

Based upon the detection reliability of the scheduling request, the scheduling request information may be transmitted through the DM-RS over a shared channel (e.g., PUSCH). More specifically, according to a specific cyclic shift selection, the user equipment may indicate a scheduling request (On/Off) status or another scheduling request (On/Off buffer status) status.

4) Piggybacking Information

In case of an LTE-A uplink transmission, the transmission signal may include multiple cluster signals. More specifically, the generated signal may be transmitted through multiple regions (clusters) each different from one another in a frequency band or uplink carrier, and the generated signal may simultaneously carry information each being different from one another, such as data or control information. In this case, the user equipment may use a method of performing resource concatenation or a method of piggybacking control information to data. More specifically, the user equipment may select a single transmission band by using a basic transmission band for performing signal transmission, and another shared channel may be encoded by using the basic transmission band, or after collecting control signals, the collected control signals may be may be piggybacked by using the basic transmission band. Information related to piggybacking or data concatenation within the corresponding transmission band may be indicated as a DM-RS being selected from Na number of cyclic shifts.

5) Interference Indicator

The LTE-A user equipment may report an interference, which occurs in a channel while a DM-RS is being transmitted through the PUSCH. The interference indicator may correspond to a specific downlink sub-band or an overall system bandwidth. Moreover, the interference indicator may also indicate a downlink carrier index, which signifies that the corresponding carrier indicates a minimum interference level or a maximum interference level.

On the other hand, the interference indicator may also indicate a corresponding cell ID included in a specific reporting cell set. whenever required, an Na cyclic shift selection may be used to indicate a concatenation of the interference indicator itself and its related parameters, such as carrier ID or cell index.

6) ACK/NACK Indicator Information

The user equipment may indicate an ACK/NACK signal, which indicates whether or not signals transmitted from the base station are received, by using the DM-RS cyclic shift selection. ACK/NACK puncturing respective to the legacy method may be prevented from occurring, when the ACK/NACK is included in a DM-RS field, among the Na number of cyclic shifts, and then transmitted. Alternatively, by using a general ACK/NACK transmission method, which is used in the legacy system, ACK/NACKs that are to be additionally transmitted are transmitted through the DM-RS field, among the Na number of cyclic shifts.

7) Carrier Aggregation Triggering Information

In case the LTE-A user equipment seeks to change a carrier aggregation configuration, the user equipment may transmit carrier aggregation triggering indicator information through a DM-RS field. Generally, a user equipment operated in a configured carrier aggregation mode. However, in comparison with the current carrier aggregation, when carrier configuration is required to be changed as a result of a low traffic load or a heavy traffic load, by using the method of selecting a DM-RS among Na number of cyclic shifts, a new carrier aggregation configuration may be disclosed.

8) Emergency Indicator

When placed in an unexpected situation or in an emergency situation, the user equipment should transmit an indicator notifying an emergency situation to the base station by using any path available. Among a plurality of methods for indicating an emergency situation from the LTE-A user equipment, the emergency situation may be notified (or indicated) by using the method of selecting a DM-RS cyclic shift selection, among Na number of cyclic shifts.

As described above, at least one or more of the control information, which may be arbitrarily selected by the user equipment and transmitted to the base station, may be simultaneously transmitted through the DM-RS field. And, an indicator information indicating the transmitted control information is not required to be separately signaled.

With respect to the diverse control information transmitted from the user equipment, the base station may perform reading on the control information by using a mapping rule based upon predetermined DM-RS indicator information, and the base station may perform control operations accordingly.

The above-described exemplary embodiments of the present invention may support the MIMO operations. More specifically, each transmission antenna (port) may support each DM-RS, and the DM-RS used in each antenna (port) may be independently selected from a pre-defined cyclic shift set.

Alternatively, the DM-RS cyclic shift may be signaled/selected/defined with respect to one reference transmission antenna (port), and another DM-RS cyclic shift may be determined from the reference DM-RS cyclic shift by using a predetermined offset.

The DM-RS transmission may be related to data traffic or may be transmitted without any other symbol.

In the above-described method for transmitting diverse control information from the user equipment by using a DM-RS selection according to the second embodiment of the present invention, when using the PUSCH, and when transmitting control information through the DM-RS field over the PUSCH, only the DM-RS is transmitted without having to transmit other separate information.

Furthermore, apart from the control information that are described in the above-described embodiments of the present invention, other control information may also be transmitted through the DM-RS, and each of the control information may be independently transmitted by using a separate signaling method other than the DM-RS, or may be grouped and then transmitted.

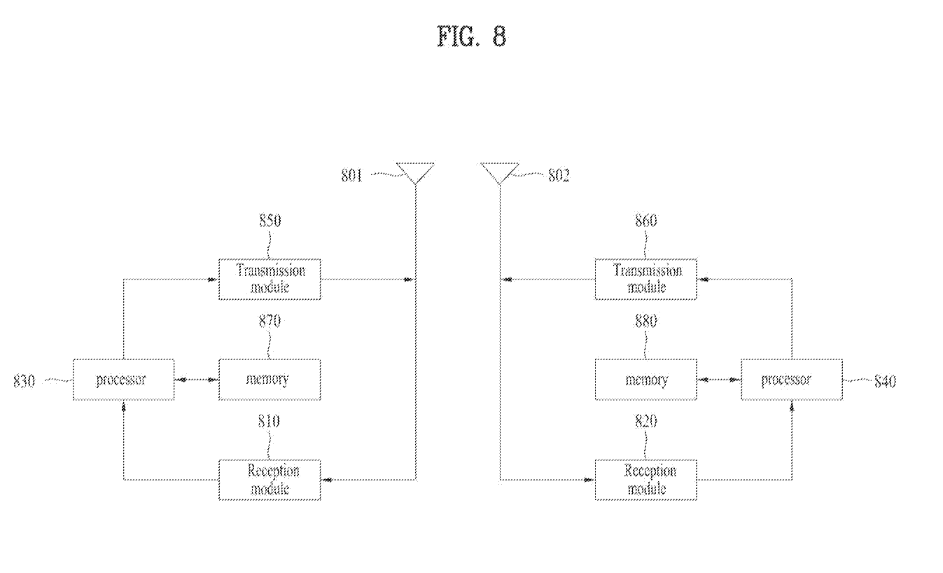

A base station and a user equipment that are capable of performing the exemplary embodiments of the present invention will now be described in detail with reference to FIG. 8.

FIG. 8 illustrates a block view showing the structures of an exemplary base station and an exemplary user terminal that can perform the embodiment of the present invention.

The user equipment may operate as a transmission device in an uplink and may operate as a reception device in a downlink. Also, the base station may operate as a reception device in an uplink and may operate as a transmission device in an uplink. More specifically, the user equipment and the base station may each include a transmission device and a reception device for transmitting information or data.

Each of the transmission device and the reception device may include a processor, a module, a part and/or means each configured to perform the exemplary embodiments of the present invention. Most particularly, the transmission device and the reception device may include a module (means) configured to encrypt a message, a module configured to translate an encrypted message, an antennae configured to transmit and receive a message, and so on.

Referring to FIG. 8, the left side represents the structure of the transmission device, which indicates a base station belonging to a DAS, and the right side represents the structure of the reception device, which indicates a user equipment accessing a cell that is serviced by the DAS base station. Each of the transmission device and the reception device may include an antenna (801, 802), a reception module (810, 820), a processor (830, 840), a transmission module (850, 860), and a memory (870, 880).

The antenna (801, 802) is configured of a receiving antenna, which performs the functions of receiving a radio signal from an outside source and delivering the received signal to the reception module (810, 820), and a transmitting antenna, which performs the function of transmitting a signal generated from the transmission module (850, 860) to the outside source. When a multiple antenna (MIMO) function is supported, at least 2 or more antennae (801, 802) may be provided herein.

The reception module (810, 820) performs decoding and demodulation on the radio signal, which is received from the outside source through the antenna, so as to recover the received radio signal to an original data format, thereby delivering the processed data to the processor (830, 840). Instead of being separated from one another, as shown in FIG. 8, the reception module and antennae may also be illustrated as a receiving unit configured to receive radio signals.

The processor (830, 840) generally controls the overall operations of the transmission device or the reception device. More specifically, a controller function for performing the above-described exemplary embodiments of the present invention, a MAC (Medium Access Control) frame variable control function based upon service characteristics and frequency environment (or condition), a Hand Over function, and authentication and encoding (or encryption) functions may be performed.

The transmission module (850, 860) may perform predetermined coding and modulation processes on data, which are scheduled by the processor (830, 840) and to be transmitted to the outside source, thereby delivering the processed data to the antenna. Instead of being separated from one another, as shown in FIG. 8, the transmission module and antennae may also be illustrated as a transmitting unit configured to transmit radio signals.

A program for processing and controlling the processor (830, 840) may be stored in the memory (870, 880). The memory (870, 880) may also perform functions for temporarily storing input/output data (in case of a mobile user equipment, uplink grant (UL Grant) allocated from the base station, system information, station identifier (STID), flow identifier (FID)), operation time, and so on.

Furthermore, the memory (870, 880) may include at least one type of storage means, such as a flash memory type, a hard-disk type, a multimedia card micro type, a card-type memory (e.g., SD or XD memory, etc.), a Random Access Memory (RAM), a SRAM (Static Random Access Memory), a Read-Only Memory (ROM), an EEPROM (Electrically Erasable Programmable Read-Only Memory), a PROM (Programmable Read-Only Memory), a magnetic memory, a magnetic disk, and an optical disk.

The processor (830) of the transmitting device performs overall control operations of the base station. And, the processor (830) of the transmitting device may perform a function of transmitting at least one or more control information, which are to be transmitted to each user equipment according to the embodiment of the present invention, as described above with reference to FIG. 6, through an indicator information respective to DeModulation Reference Signal (DM-RS), which is used for demodulating a transmission channel.

More specifically, the processor (830) of the transmitting device generates a ‘DM-RS configuration information’ including information related to a mapping rule, which is used for re-translating an indicator to control information, wherein the indicator indicates a cyclic shift of a DM-RS sequence that is used in a legacy system. Then, the processor (830) of the transmitting device may perform the function of transmitting the generated ‘DM-RS configuration information’ to the receiving device through the transmission module (850, 860). Also, the processor (830) of the transmitting device generates a ‘DM-RS indicator information’ including a DM-RS resource indicator indicating the cyclic shift information respective to the DM-RS, which is to be configured by the receiving device, and/or a DM-RS resource indicator that may be re-translated as control information. Then, the processor (830) of the transmitting device may transmit the generated ‘DM-RS indicator information’ to the receiving device through the transmission module (850).

Also, as described in FIG. 7, control information is deduced based upon the DM-RS transmitted from the receiving device. Thus, the control operation may be performed.

The processor (840) of the receiving device performs overall control operations of the user equipment. Also, according to the above described embodiment of the present invention, as shown in FIG. 6, the processor (840) of the receiving device configures a DM-RS, which is used for performing channel measurement based upon the DM-RS indicator information being transmitted from the transmitting device through the reception module (820). Then, the processor (840) of the receiving device may transmit the generated DM-RS to the transmitting device through the transmission module (860), or the processor (840) of the receiving device may re-translate the DM-RS indicator information as control information, thereby being capable of performing the respective control operations.

Furthermore, according to the embodiment of the present invention, as described above with reference to FIG. 7, based upon the DM-RS field space information, which is transmitted from the base station, among the diverse control information that are to be transmitted by the user equipment, at least one or more may be included in the DM-RS field, thereby being transmitted to the base station.

The processor (830, 840) may configure each of the control information, as described above, according to the exemplary embodiment of the present invention, so that the control information can be transmitted through a separate signaling other than the DM-RS. Meanwhile, the base station may perform a controller function for performing the above-described embodiments of the present invention, an OFDMA (Orthogonal Frequency Division Multiple Access) packet scheduling, TDD (Time Division Duplex) packet scheduling and channel multiplexing functions, MAC frame variable control function based upon service characteristics and frequency environment (or condition), a high-speed traffic real-time control function, a hand over function, authentication and encoding (or encryption) functions, packet modulation/demodulation functions for transmitting data, a high-speed channel coding function, and a real-time modem control function through at least one of the above-described modules, or the base station may further include a separate means, module, or part for performing such functions.

As described above, the detailed description of the disclosed preferred embodiments of the present invention is provided so that anyone skilled in the art can realize and carry out the present invention. In the above description, although the present invention is described with reference to the preferred embodiments of the present invention, it will be apparent to those skilled in the art that various modifications and variations can be made in the present invention without departing from the spirit or scope of the inventions.

Therefore, the present invention is not intended to limit the present invention to the embodiments presented herein. Instead, it is intended that the present invention grants a broadest range matching the principles and new characteristics disclosed herein.

### INDUSTRIAL APPLICABILITY

The exemplary embodiment of the present invention may be applied in diverse radio access systems. Examples of the diverse radio access systems may include 3GPP (3rd Generation Partnership Project), 3GPP2, and/or IEEE 802.xx (Institute of Electrical and Electronic Engineers 802) systems. In addition to the diverse radio access systems, the exemplary embodiments of the present invention may also be applied to all technical fields adopting the diverse radio access systems.

1. A method for receiving control information at a user equipment in a wireless communication system, the method comprising:
receiving a resource indicator related to a DeModulation Reference Signal (DM-RS) through a DM-RS field of a Physical Downlink Control Channel (PDCCH); and
mapping the resource indicator related to the DM-RS to the control information in accordance with a predetermined condition,
wherein the predetermined condition indicates whether information indicating the mapping of resource indicator related to the DM-RS and the control information is included in the PDCCH.

2. The method of claim 1, further comprising:
receiving DM-RS configuration information including a mapping rule from a base station,
wherein the mapping rule is for mapping the resource indicator related to the DM-RS to the control information.

3. The method of claim 1, wherein the predetermined condition includes a case when a specific field value within the DM-RS field is equal to a predetermined value indicating the control information.

4. The method of claim 3, wherein the DM-RS field includes multiple sub-fields, and
wherein, among the multiple sub-fields, a first sub-field indicates a type of the control information, and a second sub-field indicates a value of the control information.

5. The method of claim 1, wherein the control information includes DM-RS index information related to operation control of a multi-input multi-output system.

6. The method of claim 1, wherein the control information includes downlink carrier indicator information for feeding back channel estimation information.

7. The method of claim 1, wherein the control information includes uplink carrier indicator information for performing resource allocation when the user equipment performs uplink transmission.

8. The method of claim 1, wherein the control information includes information related to a feedback transmission mode, the information indicating a feedback information set which includes at least one or more uplink control information that is to be fed back by the user equipment.

9. The method of claim 1, wherein the control information includes information related to a change in Sounding Reference Signal (SRS) configuration which is to be transmitted with respect to a relay station.

10. The method of claim 1, wherein the control information includes parameter information related to a Coordinated Multi-Point (CoMP) system which is to be used in the CoMP system.

11. The method of claim 1, wherein the control information includes piggybacking control information indicating a transmission mode capable of maintaining single carrier priority levels or a multiple carrier transmission mode capable of transmitting a signal by using both a control channel and a shared channel simultaneously.

12. The method of claim 1, wherein the control information includes at least indicator information distinguishing multiple MCS/TBS operations that can be used in uplink transmission or indicator information indicating power control parameters on multiple transmission antennae.

13. (canceled)

14. A method for transmitting a reference signal from a user equipment in a wireless communication system, the method comprising:
receiving information for verifying multiple DeModulation Reference Signals (DM-RSs) from a base station; and
transmitting a specific DM-RS, among the multiple DM-RSs, to the base station through a Physical Uplink Shared Channel (PUSCH),
wherein the specific DM-RS is selected from a first DM-RS set when transmitting data, and the specific DM-RS is selected from a second DM-RS set when transmitting specific control information, and
wherein a value of the specific control information is mapped to a DM-RS included in the second DM-RS set.

15. The method of claim 14, further comprising:
receiving DM-RS configuration information including a mapping rule for mapping the specific control information to the DM-RS included in the second DM-RS set.

16. The method of claim 14, wherein the specific control information includes information on a number of successfully decoded Physical Downlink Control Channels (PDCCHs) among multiple PDCCHs received from the base station.

17. The method of claim 14, wherein the specific control information includes information on a number of physical antennae of the base station and information on power amplifier configuration, the information satisfying a predetermined condition by measuring a downlink signal received from the base station and capable of being independently used.

18. The method of claim 14, wherein the specific control information includes indicator information related to a user equipment capability, which is required when the user equipment accesses a cell region, and
wherein the indicator information related to the user equipment capability includes a number of available physical antennae of the base station, a configuration of a power amplifier than can be used independently, and information on a multiple input multiple output system or information of multiple carrier performance.

19. The method of claim 14, wherein the specific control information includes indicator information indicating a specific PUSCH having piggybacked data among multiple PUSCHs.

20. The method of claim 14, wherein the specific control information includes any one of interference information within a cell having the user equipment located therein, a reception verification signal respective to a signal received from the base station, or carrier aggregation triggering information.

21. In a wireless communication system, a user equipment comprising:
a reception module configured to receive a radio signal;
a transmission module configured to transmit a radio signal; and
a processor configured to map a DeModulation Reference Signal (DM-RS) resource indicator related to a DM-RS to control information in accordance with a predetermined condition, the DM-RS resource indicator being received from a base station through the reception module, so as to perform control operations,
wherein the DM-RS resource indicator is received through a DM-RS of a Physical Downlink Control Channel (PDCCH),
wherein the predetermined condition indicates whether information indicating the mapping between the DM-RS and the control information is included in the PDCCH, and
wherein the processor performs an operation of transmitting a DM-RS to the base station through the transmission module, the DM-RS being configured based upon DM-RS configuration information indicated by the DM-RS resource indicator.
